(19) United States
(12) Patent Application Publication
(10) Pub. No.: US 2021/0300183 A1
(43) Pub. Date: Sep. 30, 2021

(54) IN-VEHICLE DISPLAY APPARATUS, METHOD FOR CONTROLLING IN-VEHICLE DISPLAY APPARATUS, AND COMPUTER PROGRAM

(71) Applicant: DENSO CORPORATION, Kariya-city (JP)

(72) Inventors: Toshiyuki KONDO, Kariya-city (JP); Fumihiko MURASE, Kariya-city (JP); Masaaki HIROSE, Kariya-city (JP); Kazunori HIGUCHI, Nagakute-shi (JP); Yuji MURAGISHI, Nagakute-shi (JP); Toshiyuki TAGUCHI, Nagakute-shi (JP); Yoshikazu HATTORI, Nagakute-shi (JP)

(21) Appl. No.: 17/213,800

(22) Filed: Mar. 26, 2021

(30) Foreign Application Priority Data
Mar. 30, 2020 (JP) 2020-060000

(51) Int. Cl. B60K 35/00; G02B 27/00; G02B 27/01

(52) U.S. Cl. CPC B60K 35/00; G02B 27/0093; G02B 27/0101; G02B 27/0179; B60K 2370/1529; B60K 2370/31; G02B 2027/0187; B60K 2370/194; G02B 2027/0129; G02B 2027/0134; G02B 2027/0181; G02B 2027/0185; B60K 2370/736

(57) ABSTRACT

An in-vehicle display apparatus includes: an image generating unit, an emitting unit, and a reflecting unit. The image generating unit generates, for display information that is presented to a user, an image that includes a right-eye image and a left-eye image with a parallax. The emitting unit emits a projection light that is a light flux that contains the image. The reflecting unit reflects the projection light and forms a stereoscopic image that is superimposed on an outside view. The image generating unit generates the image in which a fusion distance of the stereoscopic image of the display information is changed, within a predetermined period of time, from a current visual distance to a target distance at which the display information is to be ultimately displayed.

### CROSS-REFERENCE TO RELATED APPLICATIONS

This application is based on and claims the benefit of priority from Japanese Patent Application No. 2020-060000, filed on Mar. 30, 2020. The entire disclosure of the above application is incorporated herein by reference.

### BACKGROUND

### Technical Field

The present disclosure relates to an in-vehicle display apparatus.

### Related Art

An in-vehicle display apparatus (head-up display [HUD]) is known. This display apparatus superimposes, for example, a virtual image for route guidance on an outside view obtained through a front windshield of a vehicle, and enables a driver of the vehicle to view the resultant image, in order to reduce accidents caused by distracted driving, improve convenience, and the like.

### SUMMARY

One aspect of the present disclosure provides an in-vehicle display apparatus that includes an image generating unit, an emitting unit, and a reflecting unit. The image generating unit generates, for display information that is presented to a user, an image that includes a right-eye image and a left-eye image with parallax. The emitting unit emits projection light contains the image. The reflecting unit reflects the projection light and forms a stereoscopic image that is superimposed on an outside view. The image generating unit generates the image in which a fusion distance of the stereoscopic image of the display information is changed, within a predetermined period of time, from a current visual distance to a target distance at which the display information is to be ultimately displayed.

### BRIEF DESCRIPTION OF THE DRAWINGS

In the accompanying drawings:

FIG. 1 is a schematic diagram illustrating the configuration of a vehicle system according to a first embodiment of the present disclosure;

FIGS. 2A and 2B are schematic diagrams illustrating superimposition of an outside view and a stereoscopic image;

FIG. 3 is a flowchart of steps in a display process;

FIG. 4 is a schematic diagram illustrating step S20 of the display process;

FIG. 5 is a schematic diagram illustrating steps S22 and S24 of the display process;

FIG. 6 is a schematic diagram illustrating step S32 of the display process;

FIGS. 7A and 7B are schematic diagrams illustrating step S32 of the display process;

FIG. 8 is a schematic diagram illustrating effects of the first embodiment;

FIGS. 9A and 9B are schematic diagrams illustrating a display process according to a second embodiment; and

FIG. 10 is a schematic diagram illustrating a display process according to a third embodiment.

### DESCRIPTION OF THE EMBODIMENTS

For example, WO 2017/138428 describes that, when depth of a position of a landscape on which a virtual image is superimposed changes, control is performed in the HUD such that a degree of change in a portion or an entirety of the virtual image to be displayed differs from a degree of change in depth. For example, JP-A-2017-956933 describes that, in the HUD, a difference in parallax angle between a target and a virtual image is equal to or less than 1 degree.

Here, in recent years, virtual reality (VR) technology for displaying three-dimensional stereoscopic images has become increasingly popular, primarily in movie theaters, household televisions, and the like. VR technology makes use of binocular parallax (also simply referred to as “parallax”). In binocular parallax, a real-world stereoscopic object is visible in differing positions when viewed from a right eye and a left eye. Specifically, a three-dimensional stereoscopic image can be displayed through use of an illusion that occurs in the brain as a result of a right-eye image and a left-eye image that are shown with parallax being viewed from the corresponding eyes.

Here, a case in which stereoscopic images of a plurality of objects that have differing fusion distances, such as a nearby first object and a faraway second object, are displayed is assumed. In such cases, the parallax of the nearby first object is greater than the parallax of the faraway second object. Therefore, when the right-eye image and the left-eye image are compared, the parallax that is applied to the first object is greater than the parallax that is applied to the second object. Meanwhile, when a person gazes at an object that is at a certain distance, only a single parallax matches this certain distance. An issue arises in that, when a user gazes at the faraway second object, the nearby first object is visible as a double image.

Meanwhile, use of such VR technology in the in-vehicle display apparatus (HUD) is desired. Because the HUD is mounted in a vehicle and the driver becomes the user (images are viewed during driving), safety becomes more important compared to when VR technology is used in movie theaters and household televisions. In addition, the HUD particularly has an issue in that, because the driver often gazes into the distance while driving, the nearby first object becomes more easily visible as a double image, as described above.

Therefore, in a HUD that is capable of forming a stereoscopic image, suppression of reduction in visibility caused by such double images is desired. However, in the technologies described in the WO2017/138428 pamphlet and JP-A-2017-956933, no consideration is given to the suppression of reduction in visibility caused by double images as described above.

It is thus desired to suppress reduction in visibility of a virtual image in an in-vehicle display apparatus.

One aspect of the present disclosure has been achieved to solve at least a part of the above-described issues and can be actualized according to aspects below.

(1) According to one aspect of the present disclosure, an in-vehicle display apparatus is provided. The in-vehicle display apparatus includes: an image generating unit that generates, for display information that is presented to a user, an image that includes a right-eye image and a left-eye image with a parallax; an emitting unit that emits a projection light that is a light flux that contains the image; and a reflecting unit that reflects the projection light and forms a stereoscopic image that is superimposed on an outside view. The image generating unit generates the image in which a fusion distance of the stereoscopic image of the display information is changed, within a predetermined period of time, from a current visual distance to a target distance at which the display information is to be ultimately displayed.

In the configuration, the image generating unit generates an image (right-eye image and left-eye image) with each parallax. The emitting unit emits a projection light that is a light flux that contains the image. The reflecting unit reflects the projection light and forms a stereoscopic image that is superimposed on an outside view. Therefore, the in-vehicle display apparatus that is capable of displaying a stereoscopic image that is superimposed on an outside view can be provided. As a result of the display information that is used for guidance being formed into a stereoscopic image in this manner, a positional-depth (foreground/background) relationship between guidance targets can be better understood.

In addition, the image generating unit generates the image in which a fusion distance of the stereoscopic image of the display information is changed, within a predetermined period of time, from a current visual distance to a target distance at which the display information is to be ultimately displayed. Therefore, for example, formation of a double image that accompanies the display information (stereoscopic image) being suddenly displayed at a distance that is away from the current visual distance can be suppressed. That is, for example, a situation in which nearby display information (stereoscopic image) that is suddenly displayed while a driver is gazing into the distance and driving does not fuse and forms a double image can be suppressed. Consequently, as a result of this configuration, reduction in visibility of an entire virtual image attributed to a double image can be suppressed.

(2) The in-vehicle display apparatus according to the above-described aspect may further include a line-of-sight acquiring unit that acquires a direction of a line of sight of a driver of a vehicle in which the in-vehicle display apparatus is mounted. The image generating unit may use a distance between a position of an eye of the driver and a gaze point of the driver that is estimated from the direction of the line of sight of the driver as the current visual distance.

As a result of this configuration, the image generating unit uses the distance between the position of the eye of the driver and the gaze point of the driver that is estimated from the direction of the line of sight of the driver as the current visual distance. Therefore, accuracy of the current visual distance can be improved. Consequently, formation of a double image can be further suppressed, and reduction in the visibility of an entire virtual image attributed to a double image can be further suppressed.

(3) In the in-vehicle display apparatus according to the above-described aspect, the image generating unit may change the fusion distance of the image when the target distance of the display information differs from a distance to a gaze area that includes the gaze point.

As a result of this configuration, the image generating unit changes the fusion distance of the image when the target distance of the display information differs from the distance to the gaze area that includes the gaze point.

Here, “when the target distance of the display information differs from the distance to the gaze area” refers to a case in which a risk of the display information (stereoscopic image) not fusing and forming a double image is present. That is, the image generating unit changes the fusion distance in the image only when a risk of a double image being formed is present. Consequently, reduction in the visibility of an entire virtual image attributed to a double image can be suppressed, while annoyance experienced by the user is reduced.

(4) In the in-vehicle display apparatus according to the above-described aspect, the image generating unit may further change a fusion position of the display information from the gaze point to a target position in which the display information is to be ultimately displayed.

As a result of this configuration, the image generating unit changes the fusion position of the display information from the gaze point to the target position in which the display information is to be ultimately displayed. Consequently, the gaze (attention) of the user can be drawn towards the display information and the user can be made to promptly recognize the display information.

(5) In the in-vehicle display apparatus according to the above-described aspect, the image generating unit may gradually change both parallax and size of the display information in the right-eye image and the left-eye image, within a predetermined period of time

As a result of this configuration, the image generating unit gradually changes both parallax and size of the display information in the right-eye image and the left-eye image, within a predetermined period of time. Consequently, reduction in the visibility of an entire virtual image attributed to a double image can be suppressed, while discomfort experienced by the user is reduced.

Here, the present disclosure can be actualized in various modes. For example, the present disclosure can be actualized in various modes such as an in-vehicle display apparatus, a vehicle system that includes the in-vehicle display apparatus, a method for controlling the in-vehicle display apparatus and the system, a computer program that is run in the in-vehicle display apparatus and the system, a server apparatus for distributing the computer program, and a non-transitory computer-readable storage medium that stores therein the computer program.

### First Embodiment

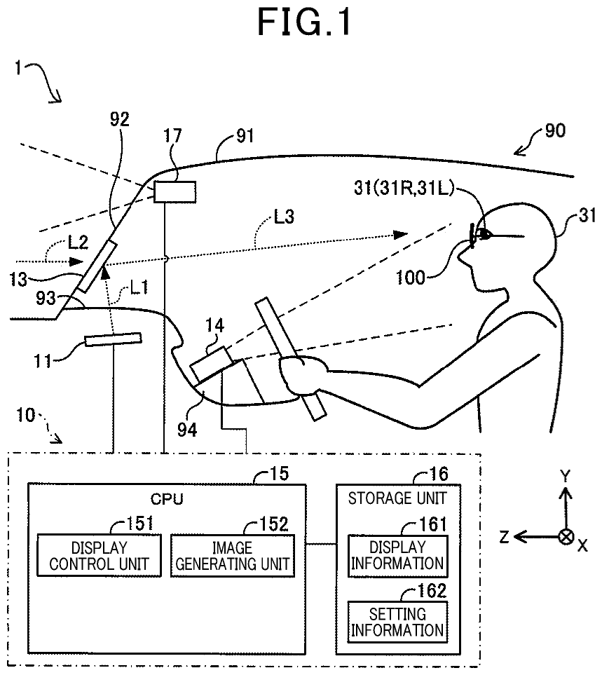

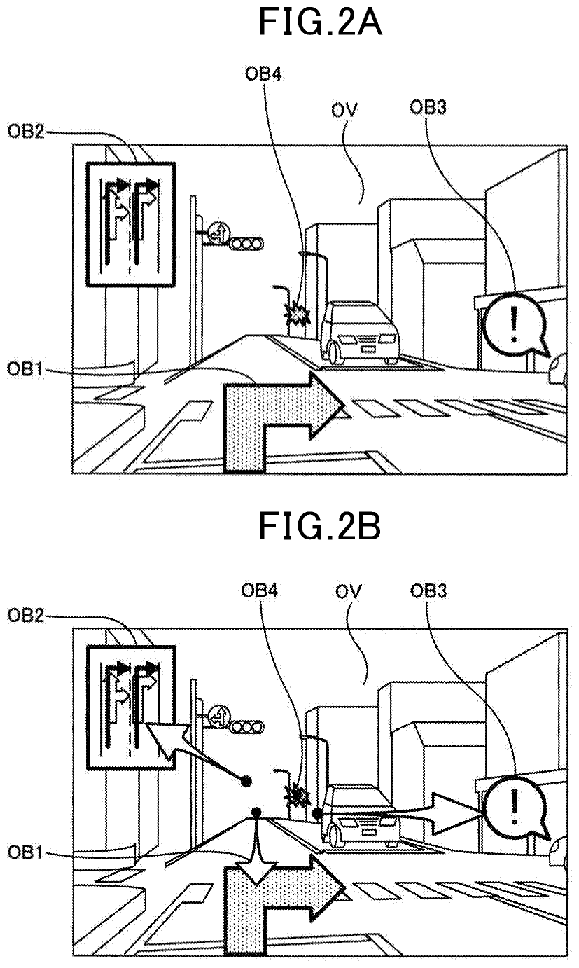

FIG. 1 illustrates a vehicle system 1 according to an embodiment of the present disclosure. FIGS. 2A and 2B illustrate superimposition of an outside view and a stereoscopic image. FIG. 2A illustrates pieces of display information OB1 to OB4 and target distances. FIG. 2B illustrates display of the pieces of display information OB1 to OB4 by the vehicle system 1 according to the present embodiment.

As shown in FIG. 1, the vehicle system 1 is a vehicle 90 in which an in-vehicle display apparatus (HUD) 10 is mounted. As shown in FIGS. 2A and 2B, a user of the vehicle system 1, that is, a driver 31 of the vehicle 90 is able to simultaneously view an outside view OV through a front windshield 92 and stereoscopic images of the plurality of pieces of display information OB1 to OB4 displayed by the in-vehicle display apparatus 10.

The in-vehicle display apparatus 10 generates a right-eye image and a left-eye image for each of the pieces of display information OB1 to OB4. The right-eye image and the left-eye image are shown with parallax that is based on a distance of the display information. The in-vehicle display apparatus 10 enables the right-eye image and the left-eye image to be viewed by the corresponding eyes of the driver 31.

As a result, the in-vehicle display apparatus 10 can display three-dimensional stereoscopic images that represent the pieces of display information OB1 to OB4 using an illusion that occurs inside the brain of the driver 31. Here, the pieces of display information OB1 to OB4 shown in FIG. 2A are displayed at distances (also referred to, hereafter, as “target distances”) at which the in-vehicle display apparatus 10 is to ultimately display the pieces of display information OB1 to OB4.

As shown in FIG. 2B, the in-vehicle display apparatus 10 according to the present embodiment first displays the pieces of display information OB1 to OB4 at current visual distances that are indicated by black circles. The in-vehicle display apparatus 10 changes fusion distances (also referred to as “imaging distances”) of the stereoscopic images representing the pieces of display information OB1 to OB4, from the current visual distances to the target distances of the pieces of display information OB1 to OB4 shown in FIG. 2A. The in-vehicle display apparatus 10 thereby suppresses reduction in visibility of an entire virtual image. Details will be described hereafter.

As shown in FIG. 1, the in-vehicle display apparatus 10 includes an emitting unit 11, a reflecting unit 13, a rear imaging unit 14, a front imaging unit 17, a central processing unit (CPU) 15, and a storage unit 16. The emitting unit 11 is provided in a dashboard 93. The reflecting unit 13 is incorporated into an inner surface of the front windshield 92. The rear imaging unit 14 is set in a center console 94. The front imaging unit 17 is set inside a roof 91. The CPU 15 is connected to the foregoing units. In FIG. 1, an X-axis corresponds to a left/right direction from the perspective of the driver 31. A Y-axis corresponds to an up/down direction from the perspective of the driver 31. A Z-axis corresponds to a front/rear direction from the perspective of the driver 31.

For example, the emitting unit 11 includes a light source, a display element, and a projection optical system. The emitting unit 11 emits a light flux (also referred to, hereafter, as “projection light”) that contains an image. For example, the light source may be a light-emitting body such as a light-emitting diode (LED), an electroluminescent (EL) element, or a laser. For example, the display element is a transmissive or self-luminous display element such as a liquid crystal display (LCD), a digital micromirror device (DMD), or a micro-electro-mechanical system (MEMS). The display element forms an image. The image that is formed by the display element is turned into a light flux (projection light) by the light source. For example, the projection optical system includes a projection lens, a mirror, and the like, and adjusts a divergence angle of the projection light.

For example, the reflecting unit 13 is a combiner and is a semi-transparent reflective sheet that is capable of combining an amount of light (transmitted light amount) that is transmitted through the reflecting unit 13 and the projection light. According to the present embodiment, the reflecting unit 13 is incorporated into the inner surface of the front windshield 92. However, the reflecting unit 13 may be fixed to the inner surface or an outer surface of the front windshield 92. Alternatively, the reflecting unit 13 may be provided separately from the front windshield 92.

For example, the rear imaging unit 14 is a camera that captures an image that includes a head portion of the driver 31. As a result of image analysis being performed on the image acquired by the rear imaging unit 14, a position (head-portion position) of the head portion of the driver 31 and a direction (line-of-sight direction) of a line of sight of the driver 31 can be acquired.

According to the present embodiment, data indicating an average of both eyes of the driver 31 is used for the line-of-sight direction. However, data of one eye (the right eye or the left eye) of the driver 31 may be used. Here, the rear imaging unit 14 can be actualized by a single camera. However, to improve accuracy of the head-portion position and the line-of-sight direction, the rear imaging unit 14 is preferably configured by a plurality of cameras.

For example, the front imaging unit 17 is a camera that captures an image of an outside view (surrounding environment) ahead of the vehicle 90, or in other words, ahead of the driver 31. As a result of image analysis being performed on the image acquired by the front imaging unit 17, positions of targets on which the plurality of pieces of display information OB1 to OB4 (FIGS. 2A and 2B) are to be superimposed and distances to the targets can be acquired. Here, the front imaging unit 17 can be actualized by a single camera. However, to improve accuracy of the position and distance of the target, the front imaging unit 17 is preferably configured by a plurality of cameras.

The CPU 15 is connected to each unit of the in-vehicle display apparatus 10, and a read-only memory (ROM) and a random access memory (RAM) (not shown). The CPU 15 controls each unit of the in-vehicle display apparatus 10 by extracting and running, in the RAM, a computer program that is stored in the ROM. In addition, the CPU 15 also functions as a display control unit 151 and an image generating unit 152.

The display control unit 151 and the image generating unit 152 control the emitting unit 11 and display a virtual image by cooperatively performing a display process, described hereafter. In the display process described hereafter, the image generating unit 152 generates the right-eye image that is viewed by a right eye 31R of the driver 31 and the left-eye image that is viewed by a left eye 31L of the driver 21. Hereafter, the right-eye image and the left-eye image are also collectively simply referred to as an “image.”

The storage unit 16 is configured by a flash memory, a memory card, a hard disk, or the like. The storage unit 16 stores therein display information 161 and setting information 162 in advance. The display information 161 includes a plurality of pieces of display information to be presented to the user (driver 31). Specifically, the display information 161 may include various types of information such as display information a1 and display information a2, described hereafter, based on functions provided in the in-vehicle display apparatus 10.

Here, the in-vehicle display apparatus 10 according to the present embodiment provides, in parallel, both a route guidance function using the display information a1 and a guidance function regarding the surrounding environment in which the vehicle 90 is traveling using the display information a2.

(a1) Display information is that which is used in the in-vehicle display apparatus 10 to perform route guidance from a departure point to a destination, and is display information OB1 and display information OB2 that are used to provide guidance in an advancing direction

(FIGS. 2A and 2B).

(a2) Display information is that which is used in the in-vehicle display apparatus 10 to performs guidance regarding the surrounding environment in which the vehicle 90 is traveling, and is display information OB3 and display information OB4 that are used to issue an alert and provide information regarding the surrounding environment (FIGS. 2A and 2B).

In an example in FIG. 2A, an arrow OB1 that indicates the advancing direction and a display OB2 of traffic lane information and the advancing direction of a road on which the vehicle 90 is traveling are given as examples of the display information a1 for route guidance. The display information a1 for route guidance may also include an arrival time to the destination, an entire route to the destination, and the like.

As the display information a2 for guidance regarding the surrounding environment, an alert display OB3 regarding a vehicle that is waiting in a cross lane and a display OB4 that gives notification of a position of a railroad crossing are given as examples. The display information a2 for guidance regarding the surrounding environment may also include accident information and regulation information regarding the road on which the vehicle 90 is traveling or roads in the vicinity, as well as alerts regarding pedestrians and other vehicles that are positioned in the vicinity, and the like.

The display information 161 may include either of the display information a1 and the display information a2. In addition, the display information 161 may include another type of display information that differs from the display information a1 and the display information a2.

The setting information 162 includes specific information related to the driver 31 to enable the driver 31 to view a stereoscopic image while minimizing double images. Specifically, the setting information 162 may include a typical position of the head portion of the driver 31 in a state in which the driver 31 is seated in a driver's seat of the vehicle 90, a distance between the right eye 31R and the left eye 31L of the driver 31, and the like. Each piece of information that is included in the setting information 162 can be set and changed by the driver 31. The setting information 162 may be omitted. Here, the CPU 15 and the storage unit 16 may be mounted by an electronic control unit (ECU).

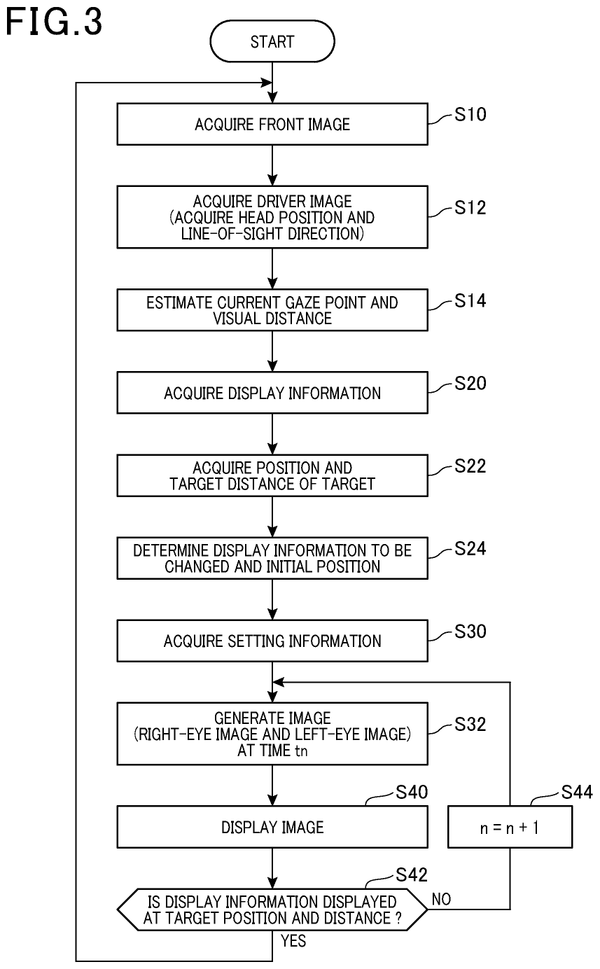

FIG. 3 is a flowchart illustrating steps in the display process. The display process is performed by the display control unit 151 and the image generating unit 152 after startup of the in-vehicle display apparatus 10. The display process is repeatedly performed while the in-vehicle display apparatus 10 is running.

First, at step S10, the display control unit 151 makes the front imaging unit 17 acquire an image (front image) of the outside view ahead of the driver 31. At step S12, the display control unit 151 makes the rear imaging unit 14 acquire an image (driver image) that includes the head portion of the driver 31. The display control unit 151 acquires the head-portion position and the line-of-sight direction of the driver 31 by performing image analysis of the acquired driver image.

Here, the line-of-sight direction that is acquired through image processing may be acquired based on a position of a pupil and an iris with an inner corner of the eye or the like as a reference point. Alternatively, the line-of-sight direction may be acquired through machine learning. In this manner, the display control unit 151 and the rear imaging unit 141 cooperatively function as a “line-of-sight acquiring unit.”

At step S14, the display control unit 151 estimates each of a current gaze point of the driver 31 and a current visual distance of the driver 31. Here, the “gaze point” refers to a point at which the driver 31 is gazing. The “visual distance” refers to a distance between the position of the eye of the driver 31 and the gaze point of the driver 31. Specifically, first, the display control unit 151 collates the line-of-sight direction of the driver 31 acquired at step S12 and the front image acquired at step S10, and estimates a target (a real-world object) at which the driver 31 is gazing. The display control unit 151 sets a position of the target at which the driver 31 is gazing as the gaze point. The gaze point is a position on an XY plane, described hereafter with reference to FIG. 5.

Subsequently, the display control unit 151 determines a distance from the vehicle 90 to the target (also referred to, hereafter, as a “first distance”) based on a size of the target at which the driver 31 is gazing in the front image. In addition, the display control unit 151 sets the head-portion position of the driver 31 acquired at step S12 as the position of the eye of the driver 31 and determines a distance (also referred to, hereafter, as a “second distance”) between the head-portion position and the front imaging unit 17. The display control unit 151 sets a distance obtained by adding the first distance and the second distance as the visual distance. The visual distance is a distance on the Z-axis, described hereafter with reference to FIG. 5.

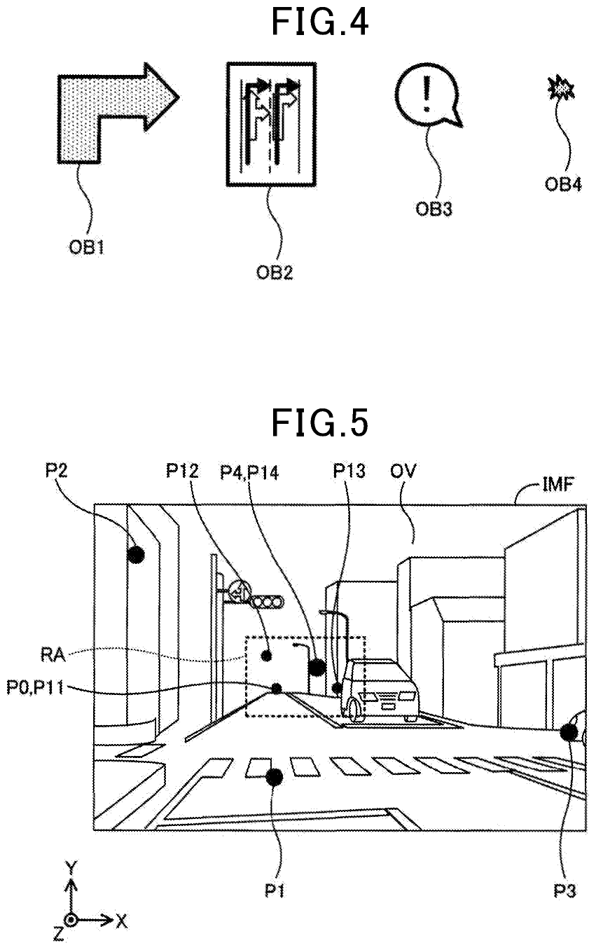

FIG. 4 illustrates step S20 of the display process. At step S20, the image generating unit 152 acquires a plurality of pieces of display information to be presented to the driver 31, from the display information 161 in the storage unit 16. As described above, the in-vehicle display apparatus 10 according to the present embodiment provides, in parallel, both the route guidance function for performing route guidance from the departure point to the destination and the guidance function regarding the surrounding environment in which the vehicle 90 is traveling. Therefore, the image generating unit 152 acquires, from the display information 161, the arrow OB1 that indicates the advancing direction, the display OB2 of the traffic lane information and the advancing direction, the alert display OB3 regarding another vehicle, and the display OB4 that gives notification of the position of a railroad crossing. Here, the display information is also referred to as an “object.”

FIG. 5 illustrates steps S22 and S24 of the display process. At step S22, the image generating unit 152 acquires positions of targets (real-life objects) on which the pieces of display information OB1 to OB4 acquired at step S20 are to be superimposed, and distances to the targets. Specifically, the image generating unit 152 acquires respective positions of targets P1 to P4 on the XY plane by performing an image analysis of a front image IMF acquired at step S10.

In addition, the image generating unit 152 acquires respective distances from the vehicle 90 to the targets P1 to P4 on the Z-axis, based on sizes of the targets P1 to P4 in the front image IMF acquired at step S10, by performing an image analysis of the front image IME.

Here, as shown in FIG. 5, arbitrary objects such as a vehicle, a road, a building on a roadside, or a crossing gate may be used as the targets P1 to P4. Here, the distances to the targets acquired at step S22 are distances (target distances) at which the in-vehicle display apparatus 10 is to ultimately display the pieces of display information OB1 to OB4. The positions of the targets acquired at step S22 are the positions (target positions) in which the in-vehicle display apparatus 10 is to ultimately display the pieces display information OB1 to OB4.

At step S24, the image generating unit 152 determines a piece of display information among the pieces of display information OB1 to OB4 acquired at step S20 of which the fusion distance is changed. Specifically, first, the image generating unit 152 prescribes a gaze area RA (broken-line frame in FIG. 5) that includes the current gaze point of the driver 31 estimated at step S14, by performing an image analysis of the front image IMF acquired at step S10. Here, the “gaze area” refers to an area within which the driver 31 is able to gaze, and is a predetermined area including the gaze point and its vicinity. Here, the gaze area differs with each individual. Therefore, information on size, shape, and the like of the gaze area unique to the driver 31 may be registered in the setting information 162 in advance. When the setting information 162 is used to prescribe the gaze area RA, step S30 (acquire the setting information), described hereafter, may be performed before step S24.

Next, the image generating unit 152 extracts a piece of display information among the pieces of display information OB1 to OB4 acquired at step S20 of which the target distance acquired at step S22 differs from the distance to the gaze area RA, and sets the extracted piece of display information as the piece of display information of which the fusion distance is changed. In an example in FIG. 5, the display information OB1 that is superimposed on the target P1, the display information OB2 that is superimposed on the target P2, and the display information OB3 that is superimposed of the target P3, of which the target distances differ from the distance to the gaze area RA are the pieces of display information of which the fusion distances are changed.

In addition, at step S24, the image generating unit 152 determines initial positions of the pieces of display information OB1 to OB3 of which the fusion distances are changed. According to the present embodiment, an example in which the distance to the gaze area RA is equal to the current visual distance of the driver 31 (step S14) is given. The image generating unit 152 determines respective positions P11, P12, and P13 that correspond to the positions of the targets P1 to P3 when an entire area of the front image IMF is reduced to the gaze area RA, and sets these positions P11, P12, and P13 as the initial positions of the pieces of display information OB1 to OB3.

Here, FIG. 5 shows an example in which the initial position P11 of the display information OB1 coincides with a current gaze point PO of the driver 31 (step S14). Here, fusion distance of the display information OB4 is not changed. Therefore, the initial position (provisionally P14) and the position of the target P4 are equal.

At step 30, the image generating unit 152 acquires specific information related to the driver 31 from the setting information 162 in the storage unit 16.

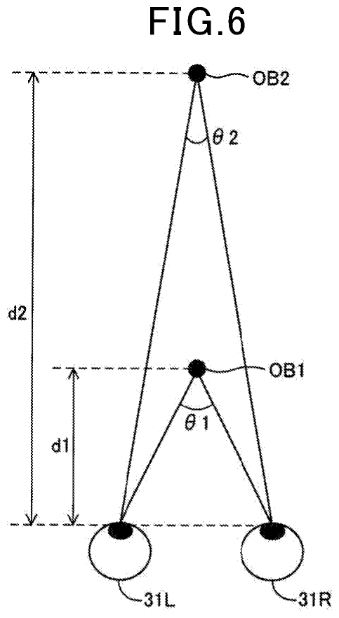

FIG. 6 illustrates step S32 of the display process. At step S32, the image generating unit 152 generates an image that includes the right-eye image and the left-eye image. As shown in FIG. 6, a parallax (also referred to as an “angle of convergence”) θ1 when the driver 31 views the display information OB1 that is at a distance d1 is known to be greater than a parallax θ2 when the driver 31 views the display information OB2 that is at a distance d2 that is farther than the distance d1. In VR technology, a three-dimensional stereoscopic image is displayed through use of such parallax.

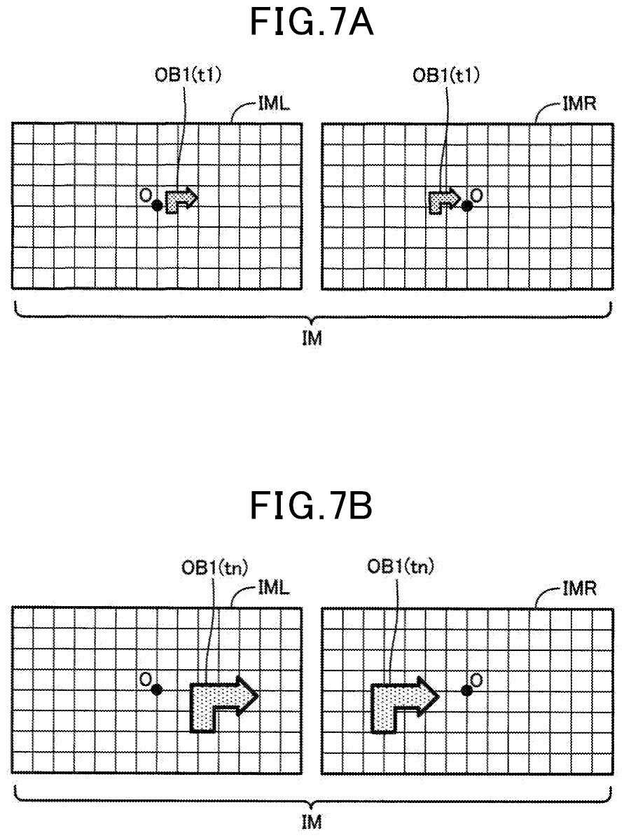

FIGS. 7A and 7B illustrate step S32 of the display process. FIG. 7A illustrates an example of an image for displaying the display information OB1 in the initial position and at the distance P11. FIG. 7B illustrates an example of an image for displaying the display information OB1 in the target position and at the distance P1.

For example, as shown in FIGS. 7A and 7B, the display information OB1 is arranged further towards a right side than a center O in a left-eye image IML, and the display information OB1 is arranged further towards a left side than the center O in a right-eye image IMR. When the left eye 31L of the driver 31 is made to view the left-eye image IML such as this and the right eye 31R of the driver 31 is made to view the right-eye image IMR such as this, the display information OB1 appears to pop out in the vicinity.

Here, in the left-eye image IML and the right-eye image IMR, the display information OB1 in FIG. 7A is arranged in a position that is closer to the center O compared to the display information OB1 in FIG. 7B because the initial distance P11 is farther than the target distance P1 and the parallax is therefore smaller. In FIGS. 7A and 7B, for convenience of description, only the above-described display information OB1 is shown. In addition, grids to enable the positions to be more easily ascertained are shown.

At step S32, the image generating unit 152 generates an image at time to (n being an integer of 1 or more). Specifically, the image generating unit 152 generates the right-eye image IMR and the left-eye image IML, in which the pieces of display information OB1 to OB4 are arranged in their respective positions at their respective distances, in their respective sizes, with their respective parallaxes, using the initial positions and distances P11 to P13 acquired at step S24 for the pieces of display information OB1 to OB4 acquired at step S20, and the specific information related to the driver 31 acquired at step S30 (FIG. 7A). In other words, an image IM that is generated by the image generating unit 152 at step S32 includes the right-eye image IMR and the left-eye image IML.

At step S40, the display control unit 151 displays the image IM generated at step S32. Specifically, the display control unit 151 makes the display element of the emitting unit 11 draw the image IM (the right-eye image IMR and the left-eye image IML). As shown in FIG. 1, the image IM that is drawn by the display element of the emitting unit 11 is turned into a light flux by the light source, and a projection light L1 that represents the image IM is emitted from the emitting unit 11.

Subsequently, the reflecting unit 13 couples the projection light L1 and outside light L2 of a field of view ahead of the driver 31. A coupled light L3 enters both eyes of the driver 31. The coupled light L3 that enters both eyes of the driver 31 is separated into the right-eye image IMR and the left-eye image IML by polarization glasses 100 worn by the driver 31. The right-eye image IMR enters the right eye 31R of the driver 31 and the left-eye image IML, enters the left eye 31L of the driver 31. As a result, the driver 31 can simultaneously view a stereoscopic image (stereoscopic image representing the image IM) that is formed by the projection light L1 and the outside view that is formed by the outside light L2.

At step S42, the display control unit 151 determines whether the pieces of display information OB1 to OB4 are displayed in the target positions and at the target distances P1 to P4 acquired at step S22. This determination can be performed using the image IM generated at step S32. When determined that the pieces of display information OB1 to OB4 are displayed in the target positions and at the distances P1 to P4, the display control unit 151 transitions the process to step S10 and repeats the processes described above. When determined that the pieces of display information OB1 to OB4 are not displayed in the target positions and at the distances P1 to P4, the display control unit 151 increments a variable n (n being an integer of 1 or more) that indicates transition of time at step S44 and transitions the process to step S32.

At step S32, the image generating unit 152 generates the image IM at subsequent time tn. Specifically, the image generating unit 152 generates the right-eye image IMR and the left-eye image IML in which the pieces of display information OB1 to OB3 (the pieces of display information of which the fusion distances are changed) acquired at step S20 are arranged in positions and at distances slightly closer to the target positions and the distances P1 to P3 from the initial positions and distances P11 to P13 acquired at step S24, in their respective sizes, with their respective parallaxes. Here, in the image IM at subsequent time tn, the display information OB4 of which the fusion distance is not changed remains arranged in the initial position and at the distance P14. Subsequently, at step S40, the display control unit 151 displays the image IM at subsequent time tn.

The display control unit 151 and the image generating unit 152 repeatedly perform the processes at steps S32 to S42 until the pieces of display information OB1 to OB3 are displayed in the target positions and at the distances P1 to P3 acquired at step S22. Ultimately, as shown in FIG. 7B, the image generating unit 152 generates the right-eye image IMR and the left-eye image IML in which the pieces of display information OB1 to OB3 (the pieces of display information of which the fusion distances are changed) are arranged in the target positions and at the distances P1 to P3, in the respective sizes, with the respective parallaxes. The display control unit 151 displays the generated right-eye image IMR and left-eye image IML. As a result, repetition of the processes at steps S32 to S42 is ended.

For example, display information OB1(t1) in the initial position and at the distance P11 shown in FIG. 7A is smaller in object size than display information OB1 (tn) in the target position and at the distance P1 shown in FIG. 7B. Therefore, to the driver 31, the image IM shown in FIG. 7A is fused as a stereoscopic image that is arranged at a distance (in other words, the current visual distance of the driver 31). Meanwhile, the image IM shown in FIG. 7B is fused as a stereoscopic image arranged nearby (in other words, at the target distance P1).

Here, an amount of time from when the display control unit 151 and the image generating unit 152 perform an initial step S40 until the display control unit 151 and the image generating unit 152 perform a final step S40 of the repetition of the processes at steps S32 to S42 is preferably equal to or greater than 0.5 seconds and equal to or less than 2.0 seconds. The amount of time that is equal to or greater than 0.5 seconds and equal to or less than 2.0 seconds is, for example, an amount of time required for a person to change parallax (angle of convergence; FIG. 6) from faraway to nearby.

Therefore, as a result of the initial to final steps S40 being performed within a period of time that is equal to or greater than 0.5 seconds and equal to or less than 2.0 seconds, the driver 31 can naturally view the piece of display information at which the driver 31 is gazing, among the stereoscopic images of pieces of the display information OB1 to OB3 of which the fusion distances have been changed, without a double image being formed. Here, the amount of time required to change parallax differs depending on the person. Therefore, information regarding an amount of time unique to the driver 31 may be registered in advance in the setting information 162.

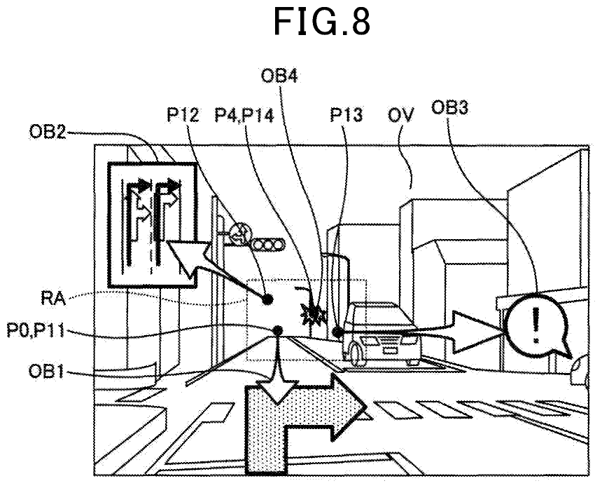

FIG. 8 illustrates effects of the first embodiment. As described above, in the in-vehicle display apparatus 10 according to the first embodiment, the image generating unit 152 generates the image IM (the right-eye image IMR and the left-eye image IML) with each parallax. The emitting unit 11 emits the projection light L1 that is a light flux that contains the image IM. The reflecting unit 13 forms a stereoscopic image that is superimposed on the outside view OV by reflecting the projection light L1.

Therefore, the in-vehicle display apparatus 10 that is capable of displaying a three-dimensional stereoscopic image that is superimposed on the outside view OV can be provided. As a result of the pieces of display information OB1 to OB4 that are used for guidance being formed into stereoscopic images in this manner, a positional-depth (foreground/background) relationship between guidance targets can be better understood.

In addition, as shown in FIG. 8, the image generating unit 152 generates the image IM in which the fusion distances of the stereoscopic images of the pieces of display information OB1 to OB3 are changed, within a predetermined period of time, from the current visual distances (that is, the initial positions and the distances P11 to P13) to the target distances (that is, the target positions and the distances P1 to P3) at which the pieces of display information OB1 to OB3 are to be ultimately displayed (repetition of the processes at steps S32 to S42 in FIG. 3).

Therefore, for example, formation of a double image that accompanies the pieces of display information OB1 to OB3 (stereoscopic images) being suddenly displayed at distances that are away from the current visual distances can be suppressed. That is, for example, a situation in which pieces of nearby display information OB1 to OB3 (stereoscopic images) that are suddenly displayed while the driver 30 is gazing into the distance and driving do not fuse and form double images can be suppressed. Consequently, as a result of the in-vehicle display apparatus 10 according to the first embodiment, reduction in the visibility of an entire virtual image due to a double image can be suppressed.

In addition, in the in-vehicle display apparatus 10 according to the first embodiment, a distance that is between the position of the eye of the driver 31 and the gaze point P0 of the driver 31 that is estimated from the direction (line-of-sight direction) of the line of sight of the driver 31 is used as the current visual distance. Therefore, accuracy of the current visual distance can be improved (step S14 in FIG. 3). Consequently, in the in-vehicle display apparatus 10 according to the present embodiment, formation of a double image can be further suppressed. In addition, reduction in the visibility of an entire virtual image attributed to a double image can be further suppressed.

Furthermore, in the in-vehicle display apparatus 10 according to the first embodiment, the image generating unit 152 changes the fusion distance in the image IM (the right-eye image IMR and the left-eye image IML) only when the target distances P1 to P4 of the pieces of display information OB1 to OB4 differ from the distance to the gaze area RA including the gaze point P0 (step S24 and steps S32 to S42 in FIG. 3).

Here, “when the target distances P1 to P4 of the pieces of display information OB1 to OB4 differ from the distance to the gaze area RA” refers to a case in which a risk is present of the pieces of display information OB1 to OB4 (stereoscopic images) forming double images due to lack of image fusing, as described above. That is, the image generating unit 152 changes the fusion distance in the image IM only when there is a risk of a double image being formed. Consequently, reduction in the visibility of an entire virtual image attributed to a double image can be suppressed, while annoyance experienced by the driver 31 (user) is reduced.

Moreover, the in-vehicle display apparatus 10 according to the first embodiment, the image generating unit 152 gradually changes both the parallax and the size of each of the pieces of display information OB1 to OB3 within a predetermined period of time, in the right-eye image IM and the left-eye image IML (steps S32 to S42 in FIG. 3, and FIGS. 7A and 7B). Consequently, in the in-vehicle display apparatus 10 according to the present embodiment, reduction in the visibility of an entire virtual image attributed to a double image can be suppressed, while discomfort experienced by the driver 31 (user) is reduced.

### Second Embodiment

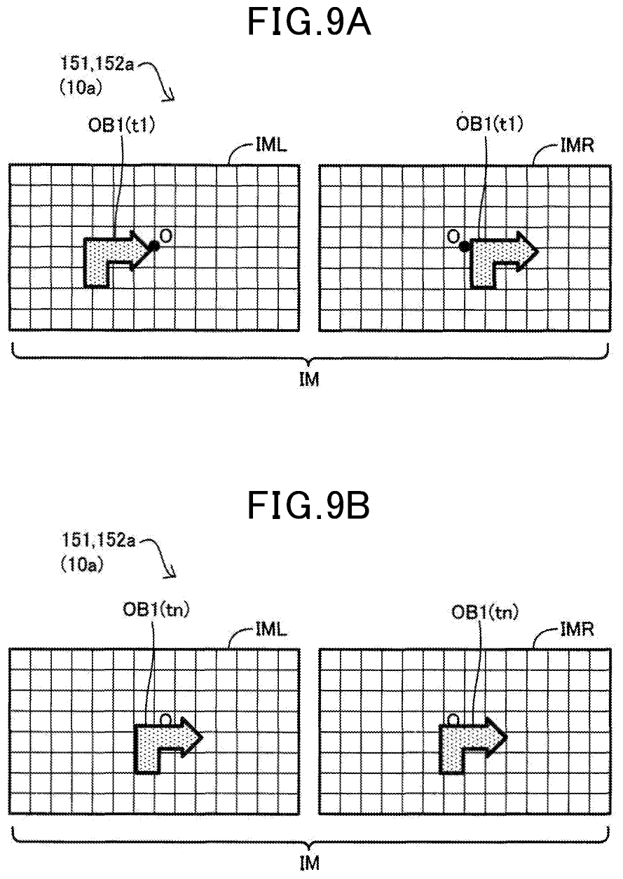

FIGS. 9A and 9B illustrate display processes according to a second embodiment. FIG. 9A illustrates an example of an image for displaying the display information OB1 in the initial position and at the distance P11. FIG. 9B illustrates an example of an image for displaying the display information OB1 in the target position and at the distance P1. In FIGS. 9A and 9B, for convenience of description, only the display information OB1 is shown. In addition, grids to enable the positions to be more easily ascertained are shown.

An in-vehicle display apparatus 10a according to the second embodiment includes an image generating unit 152a instead of the image generating unit 152. In the repetition of the processes at steps S32 to S42 of the display process described with reference to FIG. 3 according to the first embodiment, the image generating unit 152a changes only the parallax from the display information OB1(t1) in the initial position and at the distance P11 to the display information OB1(tn) in the target position and at the distance P1, and keeps the size of the object at a fixed size. As a result of this as well, to the driver 31, the image IM shown in FIG. 9A is fused as a stereoscopic image that is arranged far away (in other words, at the current visual distance of the driver 31) and the image IM shown in FIG. 9B is fused as a stereoscopic image that is arranged nearby (in other words, at the target distance P1).

In this manner, the display process of the in-vehicle display apparatus 10a can be modified in various ways. In the repetition of the processes at steps S32 to S42, only the parallaxes of the pieces of display information OB1 to OB4 may be changed, and the sizes of the objects may be kept fixed. Effects similar to those according to the first embodiment can be achieved by the in-vehicle display apparatus 10a according to the second embodiment such as this, as well.

In addition, as a result of the in-vehicle display apparatus 10a according to the second embodiment, the sizes of the stereoscopic images representing the pieces of display information OB1 to OB3 are kept fixed from the initial positions and the distances P11 to P13 to the target positions and the distances P1 to P3. Consequently, visibility of the pieces of display information OB1 to OB4 can be further improved. Moreover, in the in-vehicle display apparatus 10a according to the second embodiment, because the sizes of the pieces of display information OB1 to OB3 are kept fixed, the display process is simpler compared to the display process according to the first embodiment.

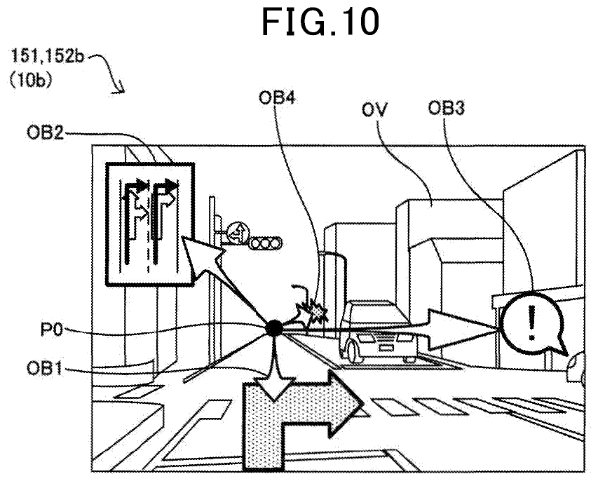

FIG. 10 illustrates a display process according to a third embodiment. An in-vehicle display apparatus 10b according to the third embodiment includes an image generating unit 152b instead of the image generating unit 152. The image generating unit 152b sets all of the pieces of display information OB1 to OB4 as the pieces of display information of which the fusion distance is changed, at step S24 of the display process described with reference to FIG. 3 according to the first embodiment.

In addition, at step S24, the image generating unit 152b sets the initial positions and the distances P11 to P14 of the pieces of display information OB1 to OB4 to the current gaze point of the driver 31 and the visual distance P0 (step S14). As a result, as shown in FIG. 10, the image generating unit 152b can change fusion positions and the fusion distances of the stereoscopic images of the pieces of display information OB1 to OB4 from the current gaze point of the driver 31 and the visual distance P0 to the target positions and the distances P1 to P4 at which the pieces of display information OB1 to OB4 are to be ultimately displayed.

In this manner, the display process of the in-vehicle display apparatus 10b can be modified in various ways. At step S24, all of the pieces of display information OB1 to OB4 may be set as the pieces of display information of which the fusion distance is changed. In addition, at step S24, the initial positions and the distances P11 to P14 of the pieces of display information OB1 to OB4 may be the current gaze point of the driver 31 and the visual distance P0.

Effects similar to those according to the first embodiment can be achieved by the in-vehicle display apparatus 10b according to the third embodiment such as this, as well. In addition, as a result of the in-vehicle display apparatus 10b according to the third embodiment, the image generating unit 152b changes the fusion positions of the pieces of display information OB1 to OB4 from the gaze point P0 to the target positions P1 to P4 in which the pieces of display information are to be ultimately displayed. Consequently, the gaze (attention) of the driver 31 (user) can be drawn towards the pieces of display information OB1 to OB4, and the driver 31 can be made to promptly recognize the pieces of display information OB1 to OB4.

### Variation Examples According to the Present Embodiment

The present disclosure is not limited to the above-described embodiments. Various modes are possible without departing from the spirit of the present disclosure. For example, the following variations are also possible. In addition, according to the above-described embodiments, a part of the configurations that are actualized by hardware may be replaced with software. Conversely, a part of the configurations that are actualized by software may be replaced with software.

### Variation Example 1

According to the above-described embodiments, an example of a configuration of an in-vehicle display apparatus is given. However, the configuration of the in-vehicle display apparatus can be modified in various ways. For example, the in-vehicle display apparatus may enable the right eye of the driver to view the right-eye image and the left eye of the user to view the left-eye image by a method other than a passive stereo method in which the polarization glasses are used, as described.

In this case, the in-vehicle display apparatus may use an active stereo method (time-division stereoscopic vision). Alternatively, the in-vehicle display apparatus may use an integral stereoscopic method. For example, various modes, such as characters, figures, symbols, and combinations thereof, can be used as the display image that is displayed as a virtual image in the in-vehicle display apparatus. In addition, the display image may be a still image or a moving image. For example, the in-vehicle display apparatus may further include an apparatus for acquiring biometric data of the driver. The setting information in the storage unit may be automatically acquired by this apparatus.

According to the above-described embodiments, an example of the display process is given (FIG. 3). However, the steps of the display process can be modified in various ways. Addition/omission/modification of processing content at each step is possible. An order in which the steps are performed may also be changed.

For example, the acquisition of the head-portion position and the acquisition of the line-of-sight direction at step S12 may be omitted. For example, at step S20, the image generating unit may receive images from another application (such as a route guidance application or an augmented reality application; not shown) that is connected to or provided inside the in-vehicle display apparatus, and use the received images as the plurality of pieces of display information. In this case, the display information in the storage unit may be omitted. For example, acquisition of the setting information at step S30 may be omitted. In this case, the setting information in the storage unit may be omitted.

For example, at step S14, the display control unit sets a distance obtained by adding a first distance from the vehicle to the target and a second distance between the head-portion position and the front imaging unit as the current visual distance of the driver. However, the display control unit may set a predetermined distance that is prescribed in advance as the current visual distance of the driver. In this case, the predetermined distance is preferably a faraway distance (such as 50 m on a general road and 100 m on an expressway) at which the driver often gazes while driving the vehicle.

For example, at step S14, the display control unit may acquire the current visual distance of the driver by another means. For example, a three-dimensional distance sensor using laser light may be mounted in the vehicle. The display control unit may set a distance to the target that is detected by the three-dimensional distance sensor as the current visual distance of the driver. In addition, for example, the display control unit may calculate the current visual distance of the driver from an angle (angle of convergence) formed by the line of sight of the right eye and the line of sight of the left eye, and a horizontal distance between both eyes.

For example, at step S14, the display control unit sets the head-portion position of the driver acquired at step S12 to be the position of the eye of the driver. However, the display control unit may directly acquire the position of the eye of the driver. The position of the eye of the driver may be acquired through image analysis of the driver image. Alternatively, the position of the eye of the driver may be acquired through use of a separate infrared sensor or the like. In addition, at step S14, the display control unit may not use the second distance, but rather set the first distance from the vehicle to the target as is as the current visual distance of the driver.

For example, at step S24, the image generating unit determines the initial positions of the pieces of display information OB1 to OB3 under a premise that the distance to the gaze area RA is equal to the current visual distance of the driver (step S14). However, the image generating unit may determine the initial positions of the pieces of display information OB1 to OB3 under a premise that the distance to the gaze area RA and the current visual distance of the driver differ (for example, the distance to the gaze area RA<the current visual distance of the driver). In this case, the image generating unit may determine an arbitrary point within the gaze area RA that is equivalent to the current visual distance of the driver and set the point as the initial positions of the pieces of display information OB1 to OB3.

For example, at step S24, the image generating unit set the initial distances of the pieces of display information OB1 to OB3 to be distances that are away from the current visual distance of the driver (step S14; in other words, the distance from the eye to the gaze point) towards the front by a depth of field of the eye. As a result, because a display that is fused within the depth of field does not easily form a double image, the formation of a double image can be further suppressed. Specifically, the image generating unit can set the depth of field towards the front to about 0.1 diopter (D). In this case, when the visual distance is 30 m (0.03 D), the initial distance of the display information is 7.5 m (0.133 D).

In addition, the image generating unit may change the depth of field based on an upward illuminance. That is, for example, the image generating unit may increase the depth of field as the upward illuminance increases. A reason for this is that, as the upward illuminance increases, a diameter of the pupils decreases and the depth of field increases. Here, for example, the image generating unit can acquire the upward illuminance from an illuminance sensor (a sensor that acquires the upward illuminance) that is provided in the vehicle.

For example, the period of time from when the display control unit 151 and the image generating unit 152 perform the initial step S40 until the display control unit 151 and the image generating unit 152 perform the final step S40 of the repetition of the processes at steps S32 to S42 may be an arbitrary amount of time differing from the above-described amount of time that is equal to or greater than 0.5 seconds and equal to or less than 2.0 seconds.

The present disclosure is described above based on the embodiments and variation examples. However, the above-described embodiments are provided to facilitate understanding of the present disclosure and do not limit the present disclosure. The present disclosure can be modified and improved without departing from the spirit and scope of claims of the invention. In addition, the present disclosure includes equivalents thereof. Furthermore, technical features may be omitted as appropriate unless described as a requisite in the present specification.

What is claimed is:

1. An in-vehicle display apparatus comprising:
an image generating unit that generates, for display information that is presented to a user, an image that includes a right-eye image and a left-eye image with a parallax;
an emitting unit that emits a projection light that is a light flux that contains the image; and
a reflecting unit that reflects the projection light and forms a stereoscopic image that is superimposed on an outside view,
the image generating unit generating the image in which a fusion distance of the stereoscopic image of the display information is changed, within a predetermined period of time, from a current visual distance to a target distance at which the display information is to be ultimately displayed.

2. The in-vehicle display apparatus according to claim 1, further comprising:
a line-of-sight acquiring unit that acquires a direction of a line of sight of a driver of a vehicle in which the in-vehicle display apparatus is mounted, wherein
the image generating unit uses a distance between a position of an eye of the driver and a gaze point of the driver that is estimated from the direction of the line of sight of the driver as the current visual distance.

3. The in-vehicle display apparatus according to claim 2, wherein:
the image generating unit changes the fusion distance of the image when the target distance of the display information differs from a distance to a gaze area that includes the gaze point.

4. The in-vehicle display apparatus according to claim 2, wherein:
the image generating unit further changes a fusion position of the display information from the gaze point to a target position in which the display information is to be ultimately displayed.

5. The in-vehicle display apparatus according to claim 1, wherein:
the image generating unit gradually changes both parallax and size of the display information in the right-eye image and the left-eye image, within a predetermined period of time.

6. The in-vehicle display apparatus according to claim 2, wherein:
the image generating unit gradually changes both parallax and size of the display information in the right-eye image and the left-eye image, within a predetermined period of time.

7. The in-vehicle display apparatus according to claim 3, wherein:
the image generating unit gradually changes both parallax and size of the display information in the right-eye image and the left-eye image, within a predetermined period of time.

8. The in-vehicle display apparatus according to claim 4, wherein:
the image generating unit gradually changes both parallax and size of the display information in the right-eye image and the left-eye image, within a predetermined period of time.

9. A method for controlling an in-vehicle display apparatus comprising:
generating, for display information that is presented to a user, an image that includes a right-eye image and a left-eye image with a parallax;
emitting a projection light that is a light flux that contains the image; and
reflecting the projection light and forming a stereoscopic image that is superimposed on an outside view; and
generating the image in which a fusion distance of the stereoscopic image of the display information is changed, within a predetermined period of time, from a current visual distance to a target distance at which the display information is to be ultimately displayed.

10. A non-transitory computer-readable storage medium on which a computer program is stored, the computer program causing a processor provided in an in-vehicle display apparatus to implement:
generating, for display information that is presented to a user, an image that includes a right-eye image and a left-eye image with a parallax;
emitting a projection light that is a light flux that contains the image;
reflecting the projection light and forming a stereoscopic image that is superimposed on an outside view; and
generating the image in which a fusion distance of the stereoscopic image of the display information is changed, within a predetermined period of time, from a current visual distance to a target distance at which the display information is to be ultimately displayed.
